(19) United States
(12) Patent Application Publication
(10) Pub. No.: US 2018/0165889 A1
(43) Pub. Date: Jun. 14, 2018

(54) Two Cameras Vehicle Recognition System and Collection Method

(71) Applicant: Qingdao Conson Jiaozhou Bay Communications Co., Ltd., Qingdao (CN)

(72) Inventors: XIAODONG LIU, Qingdao, Shandong (CN); JIANYANG ZHANG, Qingdao, Shandong (CN); SHAOSHAN YUAN, Qingdao, Shandong (CN); CHENGLEI WANG, Qingdao, Shandong (CN); LONGZHEN LIU, Qingdao, Shandong (CN); JINLONG FENG, Qingdao, Shandong (CN)

(21) Appl. No.: 15/832,675

(22) Filed: Dec. 5, 2017

(30) Foreign Application Priority Data
Dec. 9, 2016 (CN) 201611128082.3

(51) Int. Cl. G07B 15/06; G06K 9/00; G06Q 20/36; G06Q 20/08

(52) U.S. Cl. CPC G07B 15/06; G06K 9/00771; G06K 2209/15; G06Q 20/0855; G06Q 20/36

(57) ABSTRACT

This invention relates to the field of highway vehicle toll collection system and vehicle license plate recognition technology, in particular involving two cameras vehicle recognition system and collection method. It is composed of the door entry system and the photographing recognition system based on an ETC system, wherein the photographing recognition system comprises a main camera and an auxiliary camera, and the main camera and the auxiliary camera are installed from front to back respectively on two upright posts, and the data is transmitted to the computer of the toll booth through the two complementary cameras. This invention can accurately replace the existing high-speed ETC RFID (radio frequency identification) device and realize the zero-cost during the journey through the accurate recognition of the license plate and the automatic recognition and conversion of the vehicle license plate number image into the digital signal.

### TECHNICAL FIELD

This invention relates to the field of highway vehicle collection system and vehicle license plate recognition technology, particularly involving the two cameras vehicle recognition system and collection method.

### BACKGROUND TECHNOLOGIES

At present, the Electronic Toll Collection (ETC), a non-stop electronic toll collection system, is a popular collection mode. When the RFID device associated with a bank card is installed on one vehicle, the microwave-specific short-range communication is used, so the system can automatically recognize and lift lever for release to achieve automatic toll deduction without parking when the vehicle passes the high-way toll station.

1. So far, the ETC (Electronic Toll Collection System) system of the expressway toll station needs precise recognition of the vehicles, and needs to identify the vehicles, install the vehicle RFID device, occupy a certain car interior space, and the user cost is high and the equipment follow-up maintenance complex.

2. The ETC lane of the vehicle RFID device is installed while needing to install the recognition antenna equipment, with higher cost and complicated maintenance.

3. ETC system based on the RFID device, the user needs to handle the physical card of corresponding electronic wallet to realize the pre-collection or binding bank card withholding through the electronic wallet function of the physical card.

### CONTENT OF THE INVENTION

The technical problem to be solved in this invention is how to overcome the deficiencies of the prior art and provide a two cameras vehicle recognition system and a collection method.

The technical solutions adopted by the present invention to achieve the above object are: the two cameras vehicle recognition system including the door entry system and photographing recognition system based on an ETC system, the photographing recognition system is composed of a main camera and an auxiliary camera, which are installed from front to back respectively on two upright posts, and the data is transmitted to the computer of the toll booth through the two complementary cameras, data analysis and judgment are performed by the computer for further controlling the door entry system of the toll collection system.

Meantime, based on the vehicle recognition and collection system described above, the above-mentioned vehicle recognition and collection method steps are:

Meantime, based on the vehicle recognition and collection system described above, the above-mentioned vehicle recognition and collection method steps are:

(1) The vehicle enters the ETC lane, and the photographing recognition system photographs the license plate through two cameras, and transmits the license plate number to the system computer;

(2) Firstly, recognize the license plate by the main camera of the photographing recognition system;

(3) If the vehicle has a license plate recorded in the system computer database, and the license plate is registered with an electronic wallet, no other specific requirements, directly into the e-wallet collection deduction steps;

(4) As the vehicle moves forward, the auxiliary camera starts to work and carries out license plate recognition;

(5) Photographing recognition system will collect the license plate information uploaded to the system computer, through the computer comparative analysis to the next step;

(6) When the information collected by the two cameras matches inconsistently, step (3) is executed, the door entry system of the toll booth will lift lever for release and generate the normal sequence number mark by the system computer;

(7) When the information collected by the two cameras matches inconsistently and only one of them has the registration record in the system computer and has the electronic wallet bound, step (3) is executed and a suspicious sequence number mark is generated, and the bickering release;

(8) If the information collected by the two cameras matches inconsistently and neither of the two cameras has a registration record and is bound with an electronic wallet, further verification may be performed manually;

(9) When the vehicle in the step (8) is manually checked and confirmed not to be registered, manual license plate information is further inputted and then the step (3) is executed or the manual collection is implemented

(10) When the vehicle in the step (8) is manually checked and the registration is confirmed, the recognition information is corrected and the step (3) is executed.

(11) When the information collected by the two cameras match, but the electronic wallet is not registered, step (9) is executed.

Further, the electronic wallet in step (3) is a bank account bound by the vehicle through the ETC.

Further, when the balance of the e-wallet is not enough, manual payment or online payment by a client using a bundled third-party payment instrument is carried out to lift lever for release.

Further, both the main camera and the auxiliary camera are license plate recognition cameras.

This invention has the advantages that it can accurately replace the existing high-speed ETC RFID (radio frequency identification) device and realize the zero-cost during the journey through the accurate recognition of the license plate and the automatic recognition and conversion of the vehicle license plate number image into the digital signal.

### ATTACHED FIGURE

FIG. 1 the schematic diagram of the license plate recognition fees of this invention.

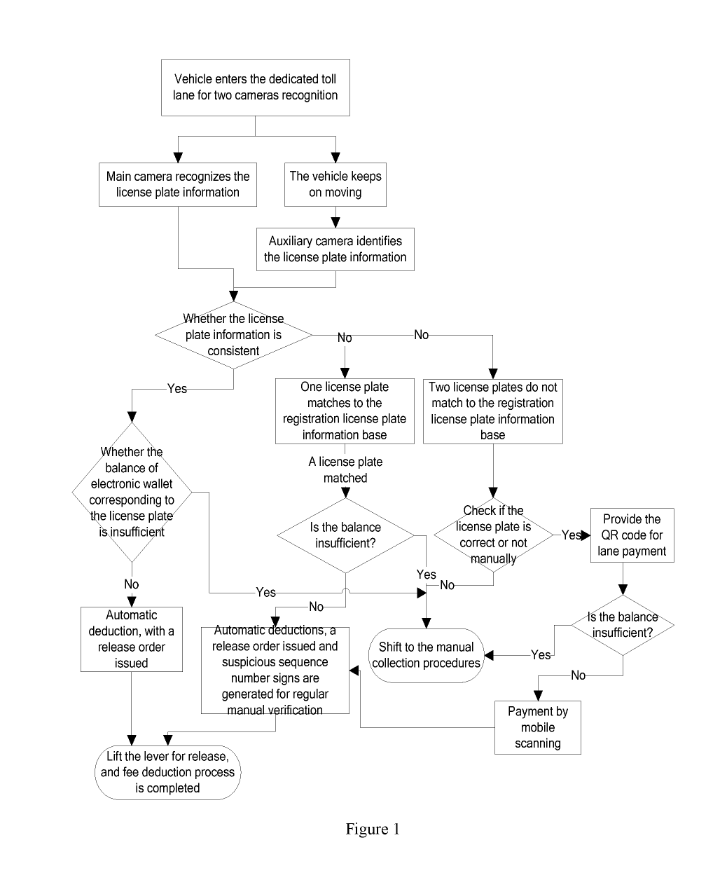

FIG. 2 the schematic structural diagram of the position of a photographing and identifying system in this invention.

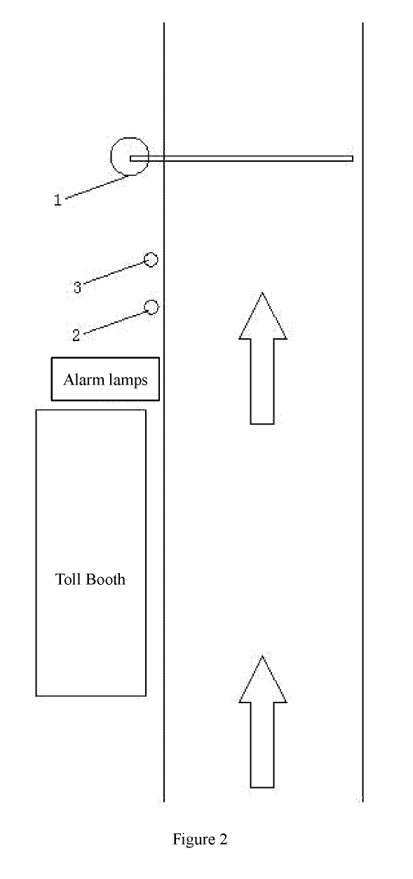

### SPECIFIC IMPLEMENTATION METHODS

Two cameras vehicle recognition system includes the door entry system 1 and photographing recognition system based on ETC system. The photographing recognition system includes main camera 2 and the auxiliary camera 3. The cameras used are license plate recognition camera. The two cameras are set to replace the traditional e-wallet card electronic recognition, so as to avoid the owner for physical card, while less recognition antenna equipment is installed toll booths, but, simplifying the system structure and reduce installation and maintenance costs; The main camera 2 and the auxiliary camera 3 are installed from front to back respectively on two upright posts, and the data is transmitted to the computer of the toll booth through the two complementary cameras, data analysis and judgment are performed by the computer for further controlling the door entry system of the toll collection system. The main camera and the auxiliary camera are license plate recognition camera. The main camera and auxiliary camera, according to the actual needs, can match the appropriate optical lens, the recognition distance is controlled at 6˜14 m and 3˜8 m range.

Meantime, based on the vehicle recognition and collection system described above, the above-mentioned vehicle recognition and collection method steps are:

(1) The vehicle enters the ETC lane, and the photographing recognition system photographs the license plate through two cameras, and transmits the license plate number to the system computer;

(2) Firstly, recognize the license plate by the main camera of the photographing recognition system;

(3) If the vehicle has a license plate recorded in the system computer database, and the license plate is registered with an electronic wallet, no other specific requirements, directly into the e-wallet collection deduction steps;

(4) As the vehicle moves forward, the No. 3 auxiliary camera starts to work and carries out license plate recognition;

(5) Photographing recognition system will collect the license plate information uploaded to the system computer, through the computer comparative analysis to the next step;

(6) When the information collected by the two cameras matches inconsistently, step (3) is executed, the door entry system of the toll booth will lift lever for release and generate the normal sequence number mark by the system computer;

(7) When the information collected by the two cameras matches inconsistently and only one of them has the registration record in the system computer and has the electronic wallet bound, step (3) is executed and a suspicious sequence number mark is generated, and the bickering release;

(8) If the information collected by the two cameras matches inconsistently and neither of the two cameras has a registration record and is bound with an electronic wallet, further verification may be performed manually;

(9) When the vehicle in the step (8) is manually checked and confirmed not to be registered, manual license plate information is further inputted and then the step (3) is executed or the manual collection is implemented;

(10) When the vehicle in the step (8) is manually checked and the registration is confirmed, the recognition information is corrected and the step (3) is executed.

(11) When the information collected by the two cameras match, but the electronic wallet is not registered, step (9) is executed.

It should be noted that the electronic wallet in step (3) is a bank account bound by the vehicle through the ETC.

When the balance of the e-wallet (bound bank account) is not enough, manual payment or online payment by a client using a bundled third-party payment instrument is carried out to lift lever for release.

The above embodiments are merely intended to illustrate the technical idea and feature of the present invention, and are designated to enable the ordinary technical personnel in the field to understand and implement the contents of the present invention, and are not used to limit the protection scope of the present invention. Any equivalent changes or modifications made according to the essence of the present disclosure shall fall within the protection scope of this invention.

What is claimed is:

1. The two cameras vehicle recognition system comprising the door entry system and the photographing recognition system based on an ETC system, which characterized by the photographing recognition system comprising the main camera and the auxiliary camera, and the main camera and the auxiliary camera are installed from front to back respectively on two upright posts, and the data is transmitted to the computer of the toll booth through the two complementary cameras, data analysis and judgment are performed by the computer for further controlling the door entry system of the toll collection system.

2. A vehicle recognition collection method, which characterized by vehicle recognition collection system based on claim 1, the vehicle recognition collection method includes the following steps:
(1) The vehicle enters the ETC lane, and the photographing recognition system photographs the license plate through two cameras, and transmits the license plate number to the system computer;
(2) Firstly, recognize the license plate by the main camera of the photographing recognition system;
(3) If the vehicle has a license plate recorded in the system computer database, and the license plate is registered with an electronic wallet, no other specific requirements, directly into the e-wallet collection deduction steps;
(4) As the vehicle moves forward, the auxiliary camera starts to work and carries out license plate recognition;
(5) Photographing recognition system will collect the license plate information uploaded to the system computer, through the computer comparative analysis to the next step;
(6) When the information collected by the two cameras matches inconsistently, step (3) is executed, the door entry system of the toll booth will lift lever for release and generate the normal sequence number mark by the system computer;
(7) When the information collected by the two cameras matches inconsistently and only one of them has the registration record in the system computer and has the electronic wallet bound, step (3) is executed and a suspicious sequence number mark is generated, and the bickering release;
(8) When the information collected by the two cameras matches inconsistently and neither of the two recognition information has a registration record, the manual verification is further performed manually.
(9) When the vehicle in the step (8) is manually checked and confirmed not to be registered, manual license plate information is further inputted and then the step (3) is executed or the manual collection is implemented;
(10) When the vehicle in the step (8) is manually checked and the registration is confirmed, the recognition information is corrected and the step (3) is executed;
(11) When the information collected by the two cameras match, but the electronic wallet is not registered, step (9) is executed.

3. The vehicle recognition collection method based on claim 2 is characterized by the following: the electronic wallet in step (3) is a bank account bound by the vehicle through the ETC.

4. The vehicle recognition collection method based on claim 2 is characterized by the following: when the balance of the e-wallet is not enough, manual payment or online payment by a client using a bundled third-party payment instrument is carried out to lift lever for release.

5. The two cameras vehicle recognition system based on claim 2 is characterized by the following: the main camera and auxiliary camera are both the license plate recognition cameras.
